(19) United States
(12) Patent Application Publication
(10) Pub. No.: US 2026/0043448 A1
(43) Pub. Date: Feb. 12, 2026

(54) ELECTROMECHANICAL WHEEL BRAKE AND METHOD FOR INSTALLING AN ELECTROMECHANICAL WHEEL BAKE

(71) Applicant: Continental Automotive Technologies GmbH, Hannover (DE)

(72) Inventors: Johann Jungbecker, Badenheim (DE); Andreas Kircher, Darmstadt (DE); Paul Linhoff, Neu-Anspach (DE); Marco Besier, Bad Schwalbach (DE)

(73) Assignee: Continental Automotive Technologies GmbH, Hannover (DE)

(21) Appl. No.: 19/100,586

(22) PCT Filed: Jul. 27, 2023
(86) PCT No.: PCT/DE2023/200156

§ 371 Date: Feb. 3, 2025

(30) Foreign Application Priority Data
Sep. 1, 2022 (DE) 10 2022 207 908.6

(51) Int. Cl. F16D 65/18; F16D 66/00; F16D 121/24; F16D 125/40; F16D 125/48; F16D 127/06; F16D 131/00

(52) U.S. Cl. CPC F16D 65/18; F16D 66/00; F16D 2066/005; F16D 2121/24; F16D 2125/40; F16D 2125/48; F16D 2127/06; F16D 2131/00

(57) ABSTRACT

An electromechanical wheel brake for a motor vehicle, has an electromotive drive assembly designed to impinge a drive shaft with a torque. A transmission assembly transmits a torque acting on the drive shaft to an output shaft. A clamping device converts a torque acting on the output shaft into a clamping force acting along a clamping direction. A clamping force sensor system determines the clamping force generated by the clamping device. A control unit controls the drive assembly on the basis of a brake request and an applied clamping force. The drive assembly, the transmission assembly and the clamping device are each functional modules which can be checked for their respective function and, in the installed state, enter into operative connection via correspondingly designed interfaces. In the installed state of the wheel brake the interfaces establish a signal connection between the control unit and the clamping force sensor system.

This U.S. patent application claims the benefit of PCT patent application No. PCT/EP2023/200156, filed Jul. 27, 2023, which claims the benefit of German patent application No. 10 2022 207 908.6, filed Aug. 1, 2022, both of which are hereby incorporated by reference.

### TECHNICAL FIELD

The embodiments relate to an electromechanical wheel brake, in particular in the form of a service brake, and to a method for installing such an electromechanical wheel brake.

### BACKGROUND

Electromechanical wheel brakes are known in many variations as service brakes in the prior art. For example, DE 10 2020 208769 A1 describes an electromechanical brake device in the form of a floating-caliper disk brake having a brake caliper and a compression piston which is mounted in the brake caliper so as to be movable in a clamping direction, wherein the brake device has an electromechanical clamping device, wherein the clamping device is supported on the compression piston on the one side, and is designed to impinge the compression piston with a force acting along the clamping direction.

Wheel brakes of this type are typically designed in accordance with a specific application scenario, such that the wheel brakes are able to provide a braking power corresponding to the specific application. For this purpose, for example, a corresponding dimensioning of the respectively used electromotive drive, of the clamping device and of the further mechanical components is selected, such that the wheel brake meets previously established specifications. In a wheel brake constructed in this manner, it is usually possible for the wheel brake to be functionally tested only in the installed state of the overall assembly of the wheel brake. Furthermore, adaptation to new operating requirements, for example in the form of a specific clamping force or dimensioning of the wheel brake, often requires a substantial and therefore expensive new construction of the wheel brake.

### SUMMARY

Against this background, an object of specifying an electromechanical wheel brake and a method for installing such a wheel brake, which method permits simple adaptation of the wheel brake to different requirements is desired.

In a first aspect, an electromechanical wheel brake for a motor vehicle, for example in the form of a service brake, has an electromotive drive assembly, wherein the electromotive drive assembly is designed to impinge a drive shaft with a torque. Furthermore, the wheel brake has a transmission assembly, wherein the transmission assembly is designed to transmit a torque acting on the drive shaft to an output shaft. The wheel brake furthermore has a clamping device, wherein the clamping device is designed to convert a torque acting on the output shaft into a clamping force acting along a clamping direction. Moreover, the wheel brake has a clamping force sensor system for determining the clamping force generated by the clamping device, and a control unit, wherein the control unit is designed to control the electromotive drive assembly on the basis of a brake request and an applied clamping force. It is provided herein that the electromotive drive assembly, the transmission assembly and the clamping device are in each case designed as functional modules which can be checked for their respective function and which, in the installed state, enter into operative connection by way of correspondingly designed interfaces, wherein the interfaces, in the installed state of the wheel brake, establish a signal connection between the control unit of the electromotive drive assembly and the clamping force sensor system.

The wheel brake can for example be a disk brake, for example in the form of a floating-caliper brake.

As a result of the design embodiment of the electromotive drive assembly, of the transmission assembly and of the clamping device as independent modules which come into operative connection only when the wheel brake is joined together, a simple adaptation of the wheel brake to the requirements of the respective application is possible. Thus, for example, the gearing ratio behavior of the transmission assembly can be changed by replacing the transmission assembly in such a way that the response speed, or the torque that can be generated, can be increased or reduced as required, wherein the clamping device and the electromotive drive can be maintained without change. Furthermore, an adaptation to the respective requirements in the installed position of the wheel brake can also take place with regard to the clamping device used, since, for example, it is furthermore also possible to use previously used transmission assemblies and electromotive drives for a clamping device with a changed geometry. Likewise, it is also possible for only the electromotive drive to be replaced by a drive with other specifications without having to make changes to the transmission assembly or the clamping device.

This effectively results in a construction kit composed of components from which a wheel brake can be assembled in accordance with the respective requirements.

It can furthermore be ensured herein that a wheel brake assembled in this way is functional by virtue of the fact that the modules used in each case can already be checked for their correct function prior to installation in the wheel brake. It is thus possible to assume correct functional capability of the wheel brake even after assembly of the wheel brake.

In order to ensure the compatibility of the modules with respect to one another, it may be that the interfaces between the modules are standardized, so that differently configured modules can enter into operative connection in the same way. An “operative connection” is to be understood here as meaning a connection in which, for example, forces are transmitted between the modules.

Since, during assembly of the modules, the interfaces at the same time also establish a signal connection between the clamping force sensor system and the control unit, such that the control unit is enabled to control the electromotive drive assembly on the basis of the determined clamping force and the braking requirement, separate wiring of the wheel brake upon installation of the modules is no longer necessary. This measure therefore also further simplifies the construction of a wheel brake adapted to individual requirements. The wording according to which the interfaces establish a signal connection can in this case be interpreted in such a way that the interfaces are part of the signal connection as well as that the signal connection is established as a result of the convergence of the interfaces. However, the signal connection herein can be established at a different point of the wheel brake and does not necessarily have to coincide with the mechanical interfaces.

It is provided here according to a embodiment that the clamping device has a rotary-translatory transmission module, wherein the rotary-translatory transmission module contains the clamping force sensor system and is embodied as a functional module that can be checked for its function. For example, the rotary-translatory transmission module can be designed as a cylindrical functional group which is inserted into the clamping device counter to the clamping direction and during active operation of the wheel brake is supported on the clamping device counter to the clamping direction.

The clamping force sensor system herein preferably contains a force sensor which is disposed in the force path between the rotary-translatory transmission module and the support thereof in the clamping device counter to the clamping direction.

According to a further embodiment, the fastening of the transmission assembly to the clamping device for transmitting a torque here is simplified in that the rotary-translatory transmission module has a rotatable threaded spindle, wherein the threaded spindle has a first mechanical interface, wherein the transmission assembly has a second mechanical interface which is counterpart to the first mechanical interface, such that, as a result of the first and the second interface being converged, a force-fitting connection for transmitting a torque is produced between the transmission assembly and the threaded spindle. In this case, the threaded spindle forms the output shaft. For example, polygonal geometries of complementary design can be used as interfaces herein. Here, a co-rotationally mounted spindle nut is preferably disposed on the threaded spindle, on which spindle nut a friction lining of the wheel brake is disposed in such a way that a torque acting on the threaded spindle is converted into a force acting on the friction lining along the clamping direction.

According to a further embodiment, the installation of the wheel brake here is further simplified by virtue of the fact that the rotary-translatory transmission module has an electrical interface, wherein the electrical interface establishes a signal connection between the clamping force sensor system and the control unit in the installed state of the rotary-translatory transmission module. For example, exposed contacts can be formed on the rotary-translatory transmission module, said exposed contacts being positioned such that, in the installed position of the rotary-translatory transmission module in the clamping device, installation of the control unit on the wheel brake electrical contacts connected to the control unit automatically come to lie on the contacts of the rotary-translatory transmission module. In this way, it is also possible, for example, to monitor the correct installed position of the components, since a signal connection, and consequently control of the wheel brake by the control unit, is possible only if all components which are involved in the production of the signal connection are correctly aligned with respect to one another.

According to a further embodiment, it is provided for the transmission of a torque from the electromotive drive assembly to the transmission assembly that a drive pinion is disposed on the drive shaft, wherein, in the installed state of the electromotive drive assembly and the transmission assembly, the drive pinion is in meshing engagement with an output pinion of the transmission assembly, such that a torque applied to the drive shaft is transmitted to the output pinion. The output pinion here does not necessarily have to represent the last gear stage in the gearing ratio of the transmission assembly from which the corresponding torque is transmitted to the clamping device. Rather, the output pinion can also be an intermediate pinion of the transmission assembly, from which a torque is transmitted to an output pinion, which is then connected directly to the clamping device.

It can be provided here that the spacing of the engagement of the output pinion in the drive pinion from the rotation axis of the output pinion remains in each case the same for different transmission assemblies in the installed state of the transmission assembly on the wheel brake. It is thus possible for the transmission assembly to be replaced by a further transmission assembly with a different gearing ratio, without having to make changes to the electromotive drive assembly or the clamping device for this purpose. Likewise, it is also possible for different electromotive drive assemblies to be coupled to the transmission assembly, with the transmission assembly remaining the same, if the electromotive drive assemblies are each equipped with a drive pinion with the same engagement radius.

According to a further embodiment, it may be furthermore provided that the control unit is formed as part of the electromotive drive assembly. In this way, signal paths between the electromotive drive assembly and the control unit can be kept very short, such that effective control of the electromotive drive assembly by the control unit is made possible.

According to a further embodiment, the operational reliability of the wheel brake herein is improved by virtue of the fact that the interfaces of the wheel brake are hermetically sealed in the installed state. It can thus be avoided that the functionality is impaired by particles or liquids which could penetrate the interfaces during operation of the wheel brake in the absence of a seal.

According to a further embodiment, it may be furthermore provided that the wheel brake has a parking brake module, wherein the parking brake module is designed to indirectly or directly block a rotation of the drive shaft in at least one direction of rotation, wherein the parking brake module is designed as a functional module which can be checked for its function. In this way, if required, the wheel brake, which is actually designed as a service brake, can also be used as a parking brake. It can be provided, for example, that the parking brake module is in each case installed for wheel brakes of the rear axle of a vehicle, with the result that a parking brake function is present here, while the parking brake module is not installed on the wheel brakes of the front axle.

In order to carry out a parking brake function, the wheel brake can be applied here up to a defined clamping force, whereupon a rotation of the drive shaft is blocked by the parking brake module in such a way that any opening of the brake is blocked. For this purpose, it is not mandatory for the parking brake module to act directly on the drive shaft. Instead, it can also be provided that a rotation or translation of an element of the transmission assembly or of the clamping device, which would lead to a reduction of an applied clamping force, is blocked by the parking brake module. Owing to the generally rigid coupling of the elements in the operative chain from the electromotive drive by way of the transmission assembly to the clamping device, a blockage of one of the elements also brings about a blockage of the other elements.

According to a further embodiment, it may be provided herein that the parking brake module has an electrically controllable actuating element for activating a blocking mechanism, wherein the actuating element is controllable by the control unit. The actuating element herein can have, for example, an actuator which is actuated by an electric motor or electromagnetically, and which is designed to position a blocking element of the blocking mechanism in such a way that the described blocking of the rotation of the drive shaft is realized.

In order to block a rotation of the drive shaft, it may be furthermore provided according to a further embodiment that the blocking mechanism has a pawl, wherein the actuating element is designed to bring the pawl into engagement with a ratchet wheel, wherein the ratchet wheel is disposed co-rotationally on the drive shaft. The ratchet wheel and the pawl herein may have a geometry which, during engagement of the pawl in the ratchet wheel, blocks a rotation of the ratchet wheel in a direction which would lead to opening of the wheel brake, while during rotation in the clamping direction continues to remain possible. For this purpose, it can be provided, for example, that the pawl is able to be displaced out of the ratchet wheel counter to a spring force, wherein the ratchet wheel has a serrated profile with in each case a steep edge and a beveled edge, with the result that, during a rotation counter to the clamping direction, the pawl can slide on the beveled edge jump into the next position between an adjacent pair of teeth of the ratchet wheel. Thus, for example, the wheel brake can be retensioned when the parking brake module is activated, without having to release the parking brake.

According to a further embodiment, the reliable locking of the wheel brake for implementing a parking brake function herein can be monitored by virtue of the fact that the parking brake module has a sensor for determining the position of the actuating element, wherein the sensor for signaling is connected to the control unit.

In a further aspect, a method for installing an electromechanical wheel brake=, wherein, for installing the wheel brake, the transmission assembly is coupled to the clamping device along the clamping direction, and wherein the electromotive drive assembly is coupled to the transmission assembly perpendicularly to the clamping direction.

### BRIEF DESCRIPTION OF THE DRAWINGS

Embodiments will be explained in detail hereunder by means of the drawings, in which:

FIG. 1 shows a perspective illustration of an exemplary wheel brake;

FIG. 2 shows a block diagram of the functional modules of an exemplary wheel brake;

FIG. 3 shows a schematic illustration of the installation directions of an exemplary wheel brake;

FIG. 4 shows a further lateral view of an exemplary wheel brake;

FIG. 5 shows a lateral view of an exemplary wheel brake;

FIG. 6 shows a perspective illustration of an exemplary brake caliper of a clamping device with a transmission assembly;

FIG. 7 shows a perspective view of an exemplary rotary-translatory transmission module;

FIG. 8 shows a sectional view of an exemplary transmission assembly;

FIG. 9 shows a schematic illustration of a first exemplary parking brake module; and

FIG. 10 shows a schematic illustration of a second exemplary parking brake module.

### DETAILED DESCRIPTION

Similar or mutually identical features hereunder are denoted by the same reference signs.

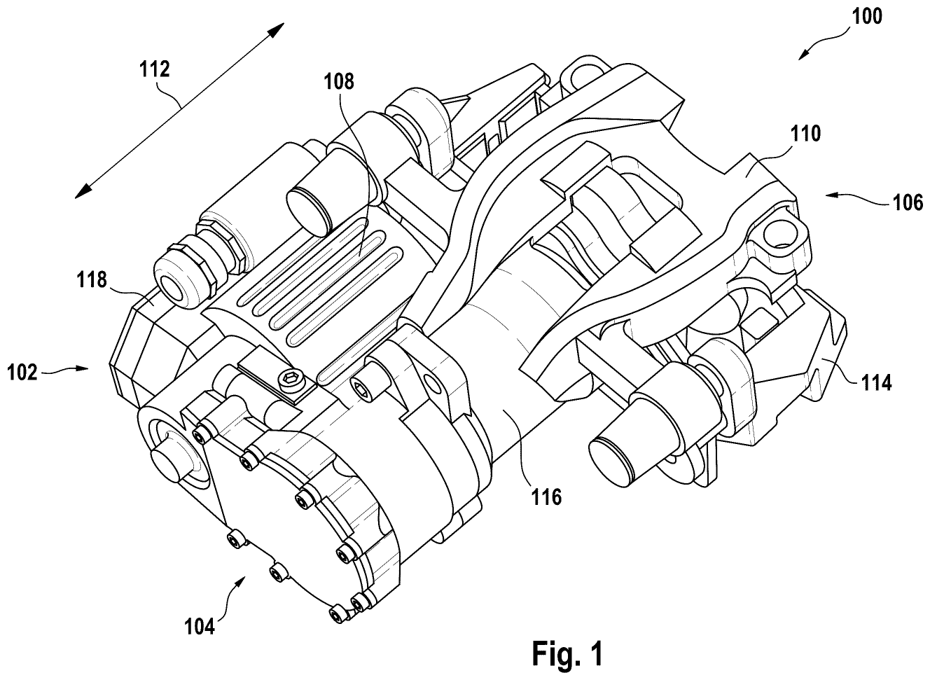

FIG. 1 shows a perspective illustration of an exemplary electromechanical wheel brake 100 in the form of a floating-caliper brake. Here, the wheel brake 100 has an electromotive drive assembly 102, a transmission assembly 104 and a clamping device 106. The electromotive drive assembly 102 has an electric motor 108 which is designed to impinge a drive shaft, which is not visible in the illustration selected, with a torque. Here, the drive shaft is connected to the transmission assembly 104 in such a way that a torque applied to the drive shaft is stepped down and transmitted to the clamping device 106.

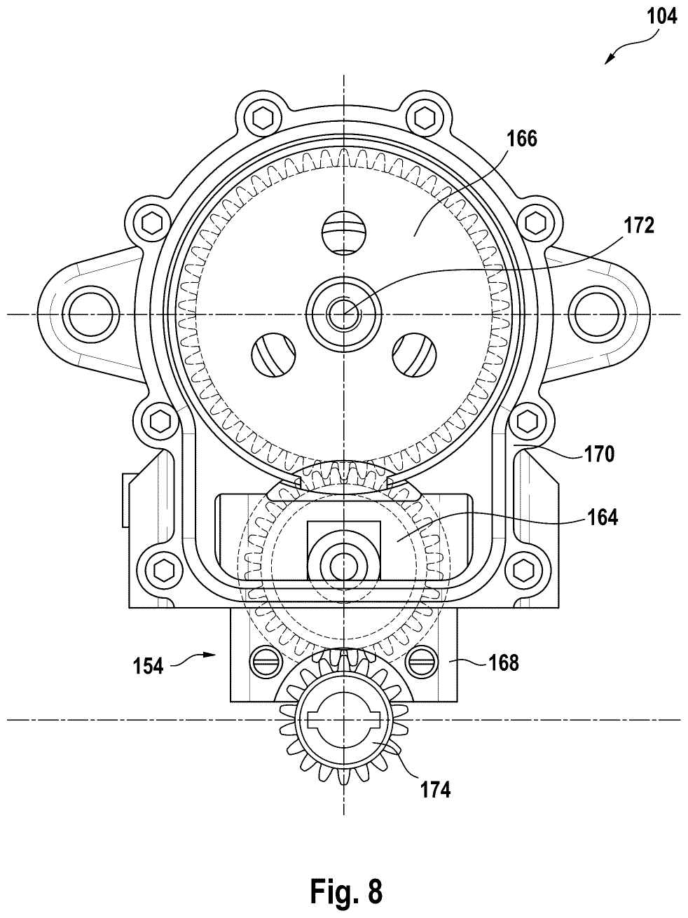

For this purpose, the transmission assembly 104 has an assembly of gearwheels, as will be explained hereunder by way of example with reference to FIG. 8.

The clamping device 106 is formed substantially by a brake caliper 110 with a rotary-translatory transmission module 116, wherein the brake caliper 110 is mounted in a brake caliper holder 114 so as to be displaceable along a clamping direction 112. Here, the brake caliper holder 114, by way of corresponding installation points, is provided to be fixedly installed on a vehicle wheel. In the illustrated assembly, the rotary-translatory transmission module 116 is connected to the transmission assembly 104 in such a way that a torque transmitted from the drive shaft to the transmission assembly 104 can be converted into a clamping force acting along the clamping direction 112 by the rotary-translatory transmission module 116.

For this purpose, the rotary-translatory transmission module 116 has a rotatably mounted threaded spindle which for transmitting a torque is connected to the transmission assembly. A spindle nut, which is secured against rotation about the threaded spindle, is in turn disposed on the threaded spindle. Consequently, a rotation of the threaded spindle leads to a translatory movement of the spindle nut along the threaded spindle, which is equivalent to the fact that a torque acting on the threaded spindle is converted into a force acting on the spindle nut along the threaded spindle and consequently in the clamping direction 112.

One of the friction linings of the wheel brake 100 here is in turn disposed on the spindle nut, such that, as a result of a rotation of the threaded spindle, a clamping force acting on a brake disk which is co-rotationally connected to a vehicle wheel is brought about by the friction linings of the wheel brake 100. The general principle of action of a floating-caliper brake is considered to be known at this point and will not be explained in more detail.

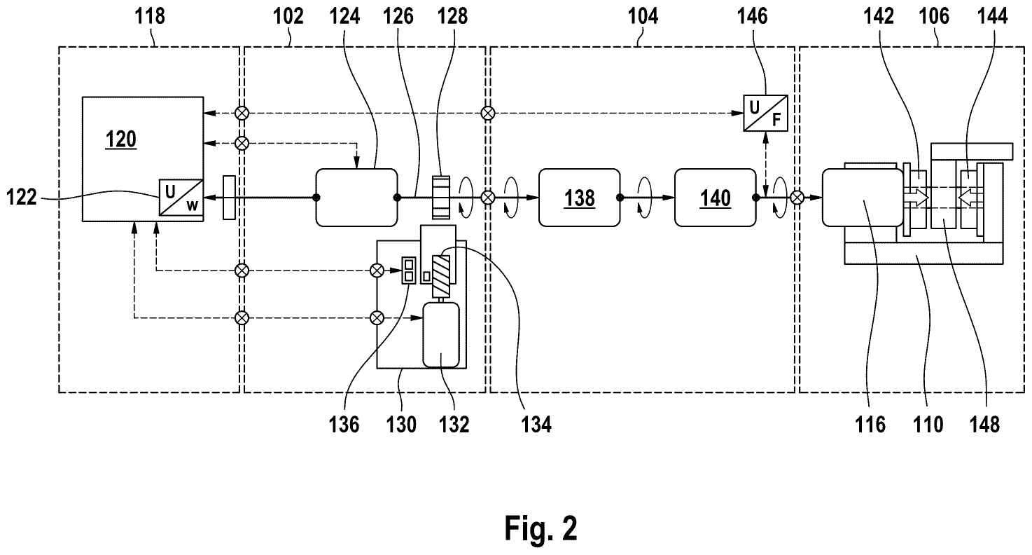

The illustrated wheel brake 100 furthermore has a control unit 118 for controlling the electromotive drive assembly 102. The functional relationship of the components of the wheel brake 100 will be described again hereunder with reference to FIG. 2.

FIG. 2 now shows a block diagram of the functional modules of the above-described exemplary wheel brake 100. Here, the control unit 118 is illustrated as the first block when viewed from left to right. The control unit 118 herein has a computing unit 120 for controlling the electromotive drive assembly 102. Furthermore, the control unit 118 has a sensor system 122 for determining operating parameters of the electromotive drive assembly 102, based on which, inter alia, open-loop or closed-loop controlling of the torque generated by the electromotive drive assembly 102 is performed.

The electromotive drive substantially has an electric motor 124, which is designed to impinge a drive shaft 126 with a torque, wherein the applied torque is predefined by a corresponding actuation of the electric motor 124 by way of the control unit 118. Here, the electric motor 124 for signaling is connected to the computing unit 120, such that operating information of the electric motor 124, such as for example a motor position, can be read out by the computing unit 120.

Here, furthermore, a ratchet wheel 128 is disposed on the drive shaft 126, said ratchet wheel, together with a parking brake module 130, providing a parking brake functionality for the wheel brake 100. For this purpose, the parking brake module 130 has an actuating element 132, wherein the actuating element 132 can be actuated by the control unit 118 by way of a corresponding signal connection. The actuating element 132 is in turn connected to a pawl 134, such that the pawl 134 can be brought into engagement with the ratchet wheel 128 by activating the actuating element 132. The pawl 134 and the ratchet wheel 128 herein are preferably designed in such a way that, when the pawl 134 engages in the ratchet wheel 128, a rotation of the drive shaft 126, which leads to an application of the wheel brake 100, continues to remain possible while a rotation of the drive shaft 124 counter to that of the drive shaft 126 is blocked. Here, the parking brake module 130 has a sensor 136 for determining the position of the actuating element 132, wherein the sensor 136 for signaling is connected to the control unit 118.

There are substantially only signaling connections, or connections for transmitting an operating voltage, between the control unit 118 and the electromotive drive assembly 102. Accordingly, an interface between the control unit 118 is limited to electrical contacts and to an assembly for fastening the control unit 118 to the electromotive drive assembly 102.

It is to be understood that by way of the interface it is also possible to transmit signals which are not used by the connected module, that is to say in the example by the electromotive drive assembly 102 module, but are relayed, in the example to a further connected transmission assembly 104 module which comprises the clamping force sensor system 146. In FIG. 2, the continuous dashed line indicates that corresponding signals are passed through at least this module 102 unchanged. Accordingly, signals which are not used by at least one of the connected modules can also be transmitted by way of the signal connection or the interface provided for this purpose.

This allows a flexible arrangement of the individual modules. Thus, for example, it is also possible to additionally insert a module between two other modules and to pass the signals that are not required through this additional module without being changed. Conversely, it is also possible to omit modules if, for example, their functionality is not required for certain applications.

If the interface is designed as a signal connection, it is possible to transmit not only electrical signals, for example an angle of rotation, but, according to a refinement of the invention, also, for example, electrical power in order, for example, to supply voltage to modules connected by way of the interface.

If the interface is also designed as a mechanical interface, for example in order to transmit forces such as torques between the modules, it goes without saying that the interface can also comprise not only the required electrical functions but also the supplementary mechanical functions. This can comprise, for example, centering, for example by way of centering pins, sealing, for example by means of sealing rings, or tolerance compensation, for example, a torque compensation.

According to a refinement, it can also be provided that at least one module has interfaces to more than one or two other modules, for example to three or to four modules. Consequently, a module can be connected to a further module, or to two modules, or to three modules, or even to four or more modules, wherein in each case at least one interface can be provided between two adjacent modules to be connected.

The electromotive drive assembly 102 is furthermore connected to the transmission assembly 104, wherein, in the illustrated embodiment, the transmission assembly 104 is embodied as a two-stage reduction transmission having a first gear stage 138 and a second gear stage 140. The transmission assembly 104 furthermore has a force sensor 146 which for signaling is connected to the control unit 118, wherein signal connection herein is designed to be indirect by way of the electromotive drive assembly 102. The force sensor 146 here can alternatively also be designed as part of the clamping device 106 and in particular be incorporated into the rotary-translatory transmission module 116.

Finally, the clamping device 106 is connected to the transmission assembly 104. Here, the clamping device is formed substantially by the brake caliper 110 and the rotary-translatory transmission module 116. The rotary-translatory transmission module 116 here is connected by way of a corresponding mechanical interface for transmitting a torque from the second gear stage 140 and is designed to convert the torque transmitted in this way into a force along the clamping direction 112. A first brake lining 142 is in turn disposed on the rotary-translatory transmission module 116, while a second brake lining 144 is disposed on the brake caliper 110 opposite the first brake lining 142. Disposed between the brake linings 142 and 144 is a brake disk 148 which, in order to retard a rotation of the brake disk 148, is clamped between the brake linings 142 and 144 and is subjected to a clamping force which brings about a torque which delays the rotation of the brake disk 148.

In the architecture of the wheel brake 100 described with reference to FIG. 2, defined electrical interfaces for transmitting signals and/or operating voltages are formed in each case between the individual functional groups, that is to say the control unit 118, the electromotive drive assembly 102, the transmission assembly 104 and the clamping device 106, and mechanical interfaces for transmitting forces or torques.

As has already been explained above, a core concept of the invention consists in designing the abovementioned functional groups in each case as functionally independent modules which can be checked for their function and which enter into operative connection by way of corresponding interfaces when the wheel brake 100 has been assembled.

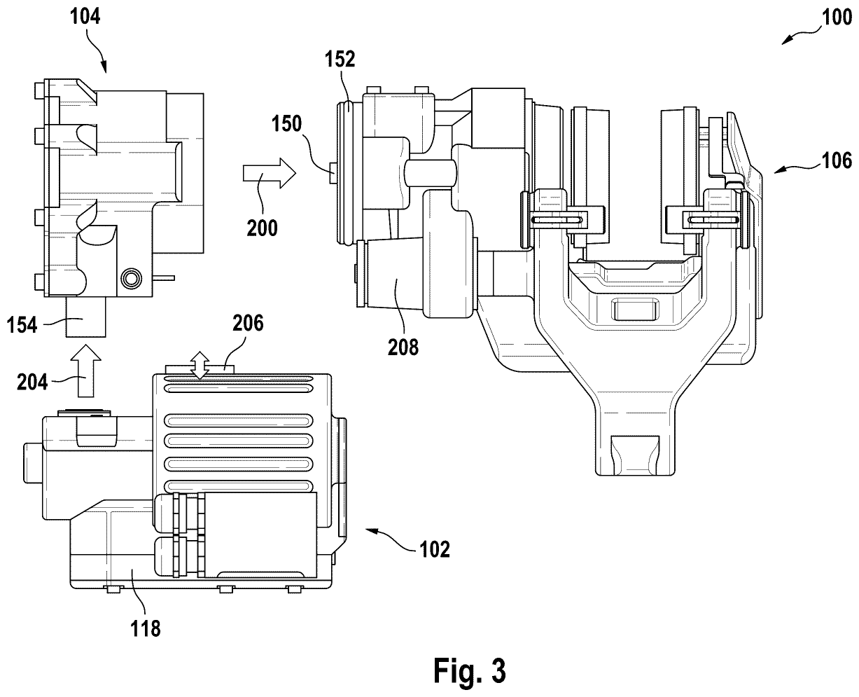

For this purpose, FIG. 3 schematically illustrates how the individual functional groups of the wheel brake 100 engage in one another, by virtue of the installation directions and interfaces of the individual functional groups being illustrated schematically. In the illustration in FIG. 3, the control unit 118 here is formed as part of the electromotive drive assembly 102 and is attached to the underside of the electromotive drive assembly 102.

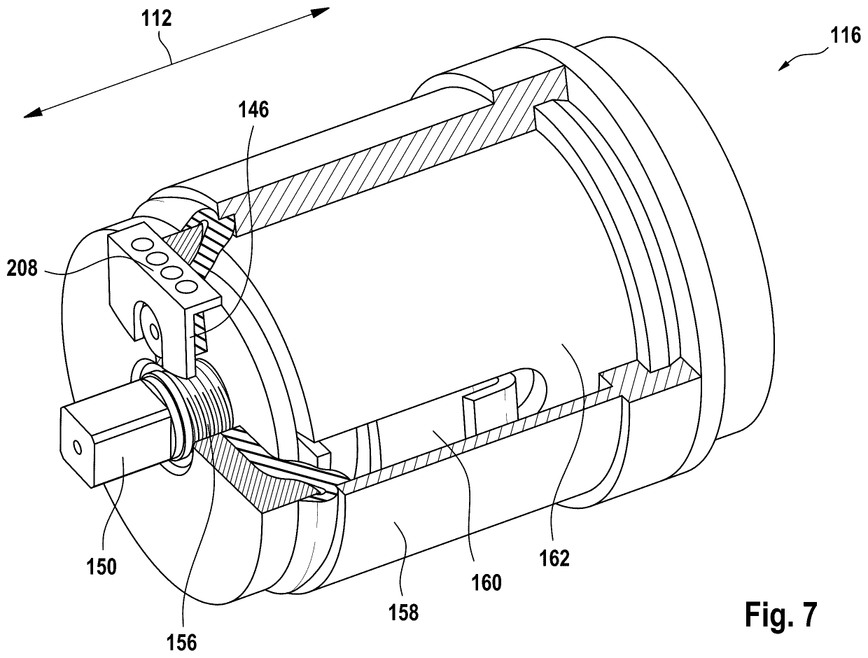

As indicated by the arrow 200 in FIG. 3, for the installation of the wheel brake 100, firstly the transmission assembly 104 is disposed on the clamping device 106 from the left. For this purpose, the rotary-translatory transmission module 116 has a mechanical interface 150 in the form of a square which, when the transmission assembly 104 is mounted on the clamping device 106, is brought into engagement with a corresponding counterpart geometry of the transmission assembly 104, such that a torque can be transmitted from an output gearwheel of the transmission assembly 104 to the threaded spindle rotary-translatory transmission module 116. The specific structure of the transmission assembly will be explained hereunder with reference to FIG. 8, while the rotary-translatory transmission module 116 is illustrated in FIG. 7.

Here, an encircling sealing ring 152 is disposed on the clamping device 106 in the installation region of the transmission assembly 104, such that the mechanical interface between the transmission assembly 104 and the clamping device 106 is hermetically protected against contamination.

As further indicated by the arrow 202, the electromotive drive assembly 102 is coupled to the transmission assembly 104 from below. For this purpose, the transmission assembly in turn has an interface 154 which is brought into operative connection with the drive shaft 126 when the electromotive drive assembly 102 is fastened to the transmission assembly 104.

Furthermore, a schematically illustrated first electrical interface 206 herein is disposed on the upper side of the electromotive drive assembly 102, wherein a second electrical interface 208, which is counterpart to the first electrical interface 206, is disposed on the clamping device 106. It is provided in the illustrated configuration of the wheel brake 100 here that the clamping force sensor system is provided in the form of a force sensor 146 in the clamping device. Accordingly, an applied clamping force, measured by the force sensor 146, can be read out by the control unit 118 by way of the interfaces 206 and 208 and used as a basis for controlling the electromotive drive assembly 102.

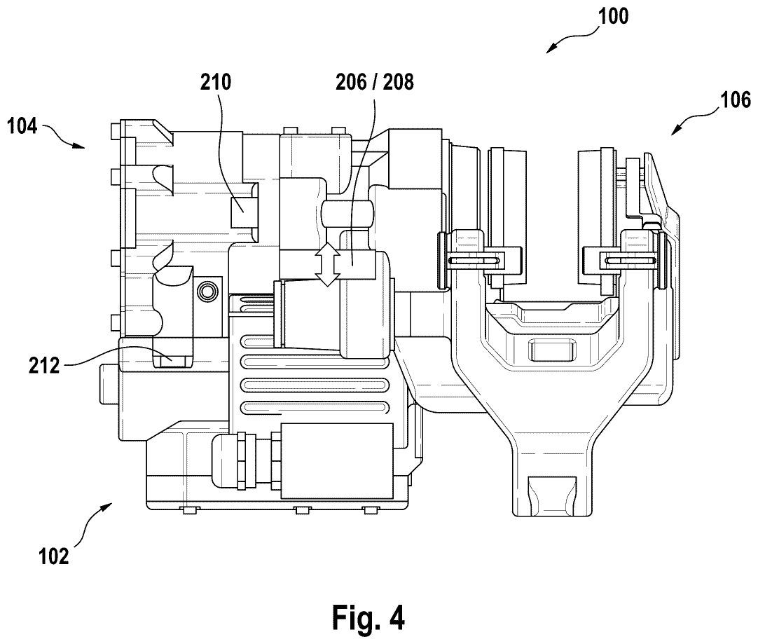

FIG. 4 illustrates the wheel brake 100 once again in the fully installed state. Here, it is once again schematically indicated that, as a result of the installation of the transmission assembly 104 on the clamping device 106 and of the electromotive drive assembly 102 on the transmission assembly 104, the electrical interfaces 206 and 208 also automatically come into operative connection, such that a measured clamping force can be transmitted to the control unit 118. As furthermore illustrated in FIG. 4, the transmission assembly is fastened to the clamping device 106 by way of a first screw connection 210, while the electromotive drive assembly 102 is fastened to the transmission assembly by way of a second screw connection 212.

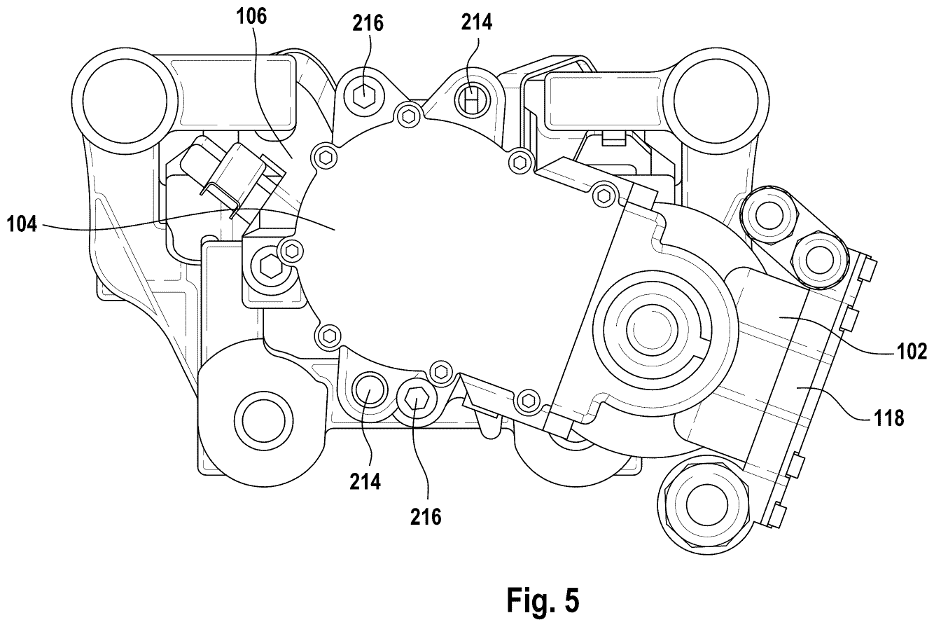

FIG. 5 illustrates a lateral view of the wheel brake 100 discussed above, viewed in the direction of the arrow 200 in FIG. 3. Here, for example, the installation points 214 for fixing the transmission assembly 104 to the clamping device 106 can be seen in this illustration. As also illustrated in FIG. 5, the clamping device 106 has alternative installation points 216 for fixing the transmission assembly 104 to the clamping device 106, said installation points allowing the transmission assembly 104 to be installed, in the case of which the transmission assembly 104 can be fastened to the clamping device 106 in a mirror image about the vertical axis of the wheel brake 100. In this way, the wheel brake 100 can be configured for both a right vehicle side and a left vehicle side by fastening the transmission assembly 104 to the clamping device 106 in the corresponding orientation.

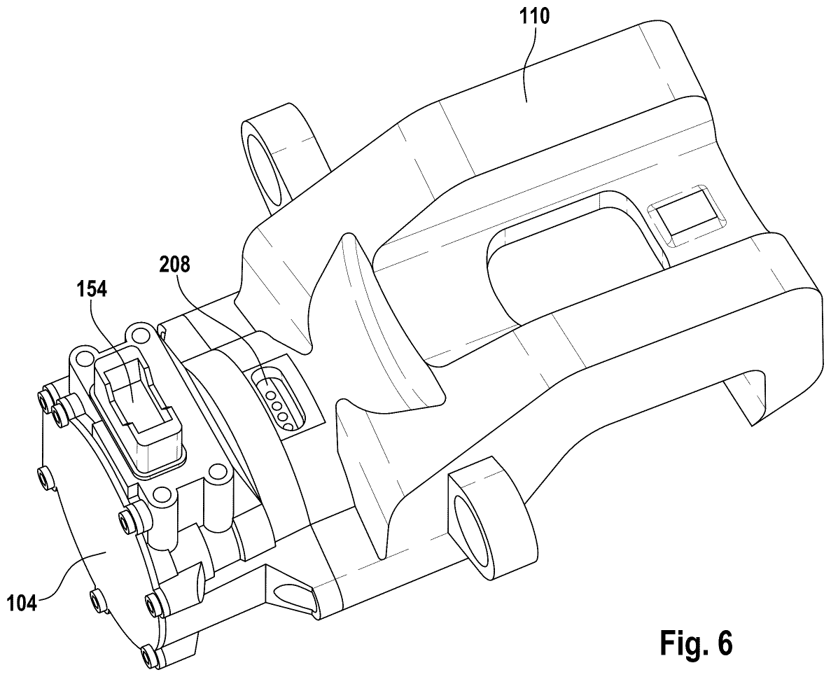

FIG. 6 shows the combination of a brake caliper 110 and a transmission assembly 104 in a view from below. Here, firstly, the mechanical interface 154 for transmitting a torque from the drive shaft 126 of the electromotive drive assembly 102 to the transmission assembly 104 can be clearly seen. This will be discussed hereunder with reference to FIG. 8. On the other hand, FIG. 6 also clearly shows the electrical interface 208 once again, by way of which a signal connection is established between the clamping force sensor system 146 disposed in the rotary-translatory transmission module 116 and the control unit 118 when the electromotive drive assembly 102 is installed on the transmission assembly 104.

FIG. 7 shows a perspective view of a rotary-translatory transmission module 116, as can be used in the assembly of FIG. 6. Here, the rotary-translatory transmission module 116 has a threaded spindle 156 which is mounted rotatably in a housing 158 and is axially supported in the housing 158 counter to the clamping direction 112. Once again, a spindle nut 160 is disposed on the threaded spindle 156, said spindle nut being co-rotationally mounted in the housing 158 in such a way that a rotation of the threaded spindle 156 about its longitudinal axis leads to a translatory movement of the spindle nut 160 along the threaded spindle 156 and consequently along the clamping direction 112. The spindle nut 160 is in turn connected to a compression piston 162, wherein the compression piston 162 is mounted in the housing 158 so as to be displaceable along the clamping direction 112. The brake lining 142 would then be disposed on the compression piston 162 in the installation position of the rotary-translatory transmission module 116.

Here, the clamping force sensor system 146 is disposed between the axial support of the threaded spindle 156 in the housing 158 and the housing 158 per se, such that a force effected by the compression piston 162 on the brake lining 142 and consequently the brake disk 148 is likewise also introduced into the clamping force sensor system 146. In this way, a clamping force applied by the wheel brake 100 can be measured directly.

The rotary-translatory transmission module 116 here is designed in the form of a functional module and has the mechanical interface 150 for producing an operative connection for transmitting a torque to the transmission assembly 104, and the electrical interface 208 for transmitting a clamping force determined by the force sensor 146 to the control unit 118.

FIG. 8 shows a sectional view of an exemplary transmission assembly 104. Here, the transmission assembly 104 is designed as a two-stage reduction transmission and has a first output pinion 164, and a second output pinion 166 which engages in the first output pinion 164. Here, the first output pinion 164 forms an intermediate pinion of the transmission assembly 104. The second output pinion 166 here has a mechanical interface 172 for connecting the threaded spindle 156 of the rotary-translatory transmission module 116 for transmitting a torque, wherein the interface is disposed so as to be centered on the rotation axis of the second output pinion 166. Here, the first output pinion 164 forms the mechanical interface 154 conjointly with a corresponding sleeve geometry 168 of the housing 170 of the transmission assembly 104. As illustrated in FIG. 8, when the electromotive drive assembly 102 is coupled, a drive pinion 174 disposed on the drive shaft 126 engages in the first output pinion 164 in such a way that a torque is transmitted from the drive shaft 126 to the transmission assembly 104. In this case, the transmission assembly can

[symbol]

Here, the transmission assembly 104 can be replaced by a transmission assembly having a different gear ratio behavior with little complexity, as long as the spacing between the drive shaft 126 and the interface 172 is maintained. An adaptation of the clamping device 106 or of the electromotive drive assembly 102 is not necessary in this case.

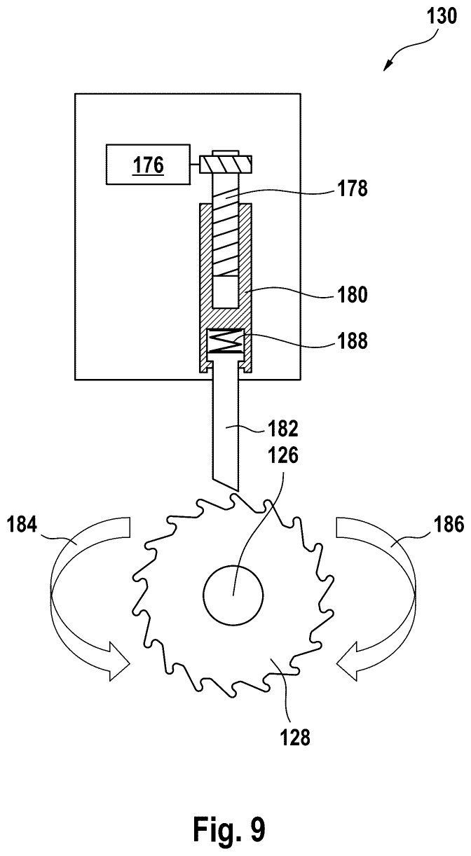

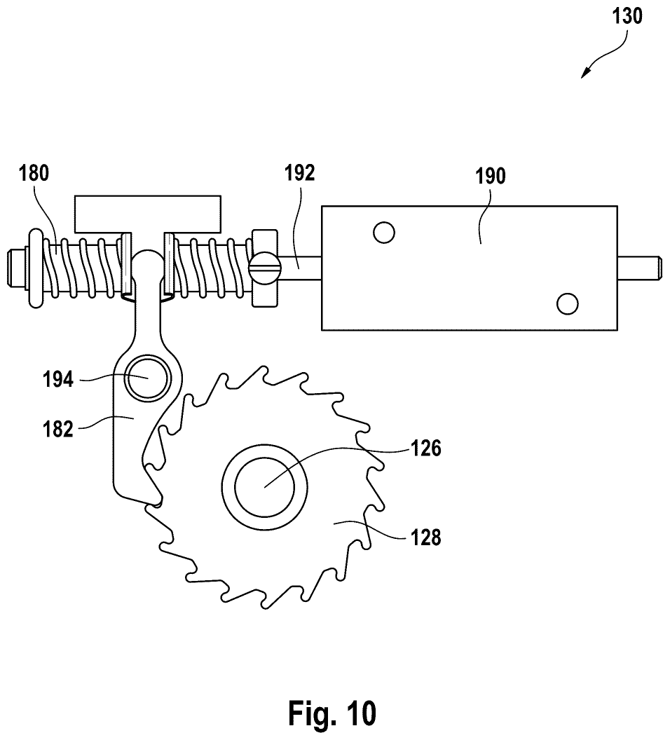

FIGS. 9 and 10 show two exemplary embodiments of parking brake modules 130. FIG. 9 here shows a variant of a parking brake module 130 with an electromotive activation. Here, the actuating element 132 of the parking brake module is formed by an electric motor 176 which is designed to effect a torque on a threaded spindle 178. An activating plunger 180 is in turn co-rotationally disposed on the threaded spindle 178 in such a way that a rotation of the threaded spindle 178 leads to a translatory movement of the activating plunger 180 along the threaded spindle 178. Here, a spring-loaded pawl 182 is disposed on the underside of the activating plunger 180.

In the illustration selected in FIG. 9, the parking brake module 130 is in the deactivated state. When the parking brake module 130 is activated by the control unit 118, the electric motor 176 is actuated in such a way that the activating plunger 180 is displaced downward and consequently the pawl 182 comes into engagement with the ratchet wheel 128. On account of the geometry of the toothing of the ratchet wheel 128, a rotation of the drive shaft 124 counter to the activation direction (counterclockwise in the illustration of FIG. 9, illustrated by arrow 184), that is to say that direction of rotation that would lead to a reduction in the clamping force of the wheel brake 100, is blocked in the process. However, a rotation in the activation direction 186 is still possible since the pawl 182 can slide on the flat geometry of the toothing of the ratchet wheel 128 and, in the process, is displaced, counter to the restoring force of the spring 188, in the direction of the activating plunger 180. In this way, the ratchet wheel 128 can be rotated in the direction 184 until the pawl 182 comes to rest in an adjacent trough of the toothing of the ratchet wheel 128, as a result of which a new locking position is established. In this way, the wheel brake 100 can also be retensioned when the parking brake function is activated without releasing the parking brake.

FIG. 10 shows an alternative design embodiment of a parking brake module 130. Here, instead of an electromotive drive, a monostable or bistable lifting magnet 190 is used as the actuating element 132, which lifting magnet is connected by way of a push rod 192 to an activating plunger 180, in which a pawl 182 is likewise mounted in a spring-loaded manner. Here, in this embodiment, the pawl 182 is mounted so as to be rotatable about an axis 194, such that a movement of the activating plunger 180 along a direction orthogonal to the axis 194 leads to a rotation of the pawl 182 about the axis 194, such that the pawl can be brought into engagement with the ratchet wheel 128. In this configuration too, the spring-loaded mounting of the pawl 182 on the activating plunger 180, in a manner analogous to the embodiment of FIG. 9, ensures that a rotation of the ratchet wheel 128 in the activation direction continues to remain possible, while a rotation counter to the activation direction is blocked.

Here, the described parking brake modules 130 may be embodied as testing-capable modules, such that, even in the non-installed state of the parking brake modules 130 on the wheel brake 100, it is possible to check whether the activation of the parking brake module 130, that is to say the displacement of the activating plunger 180 and consequently of the pawl 182, functions as desired. Furthermore, herein it is also possible to check whether the sensor system 136 for detecting the switching state of the parking brake module 130 functions as desired.

In order to dispose the parking brake module 130 on the wheel brake 100, it is merely necessary here to provide a mechanical interface which allows the pawl to engage in the ratchet wheel 128, and an electrical interface for actuating the respective actuating element 132 and for reading out data from the sensor 136.

The parking brake module 130 has been described above in such a manner that a rotation of the drive shaft 126 of the electromotive drive assembly 102 is blocked directly by the parking brake module 130. In principle, the parking brake module 130 can also block the application mechanism in the described manner at a different point of the operative chain. For example, the parking brake module 130 can also act directly on elements of the transmission assembly 104 or of the clamping device 106.

1. An electromechanical wheel brake for a motor vehicle, comprising:
an electromotive drive assembly, designed to impinge a drive shaft with a torque,
a transmission assembly designed to transmit a torque acting on the drive shaft to an output shaft,
a clamping device is designed to convert a torque acting on the output shaft into a clamping force acting along a clamping direction,
a clamping force sensor system for determining the clamping force generated by the clamping device, and
a control unit, wherein the control unit is designed to control the electromotive drive assembly on the basis of a brake request and an applied clamping force,
wherein the electromotive drive assembly, the transmission assembly and the clamping device are in each case-designed as functional modules which can be checked for their respective function and which, in the installed state, enter into operative connection by way of correspondingly designed interfaces,
wherein the interfaces, in the installed state of the wheel brake establish a signal connection between the control unit of the drive assembly and the clamping force sensor system.

2. The electromechanical wheel brake as claimed in claim 1, wherein the clamping device has a rotary-translatory transmission module, wherein the rotary-translatory transmission module contains the clamping force sensor system and is a functional module that can be checked for its function.

3. The electromechanical wheel brake as claimed in claim 1, wherein signals which are passed unchanged through at least one of the modules connected by way of the interface are transmitted by way of the interface.

4. The electromechanical wheel brake as claimed in one claim 1, wherein electrical power can be transmitted by way of the interface.

5. The electromechanical wheel brake as claimed in claim 1, wherein the interface comprises centering and/or a mechanical tolerance compensation and/or a seal in such a way that the interfaces of the wheel brake are hermetically sealed in the installed state.

6. The electromechanical wheel brake as claimed in claim 1, wherein at least one module has interfaces to more than two other modules.

7. The electromechanical wheel brake as claimed in claim 1, wherein the rotary-translatory transmission module has a rotatable threaded spindle, wherein the threaded spindle has a first mechanical interface, wherein the transmission assembly has a second mechanical interface which is counterpart to the first mechanical interface, such that, as a result of the first interface and the second interface being converged, a force-fitting connection for transmitting a torque is produced between the transmission assembly and the threaded spindle.

8. The electromechanical wheel brake as claimed in claim 1, wherein the rotary-translatory transmission module has an electrical interface, wherein the electrical interface establishes a signal connection between the clamping force sensor system and the control unit in the installed state of the rotary-translatory transmission module

9. The electromechanical wheel brake as claimed in claim 1, wherein a drive pinion is disposed on the drive shaft, wherein, in the installed state of the electromotive drive assembly and the transmission assembly, the drive pinion is in meshing engagement with an output pinion of the transmission assembly, such that a torque applied to the drive shaft is transmitted to the output pinion.

10. The electromechanical wheel brake as claimed in claim 1, wherein the control unit is designed as part of the electromotive drive assembly.

11. The electromechanical wheel brake as claimed in claim 1, wherein the wheel brake has a parking brake module, wherein the parking brake module is designed to indirectly or directly block a rotation of the drive shaft in at least one direction of rotation, wherein the parking brake module is designed as a functional module which can be checked for its function.

12. The electromechanical wheel brake as claimed in claim 11, wherein the parking brake module has an electrically controllable actuating element for activating a blocking mechanism, wherein the actuating element is controllable by the control unit.

13. The electromechanical wheel brake as claimed in claim 12, wherein the blocking mechanism has a pawl, wherein the actuating element is designed to bring the pawl into engagement with a ratchet wheel, wherein the ratchet wheel is disposed co-rotationally on the drive shaft.

14. The electromechanical wheel brake as claimed in claim 12, wherein the parking brake module has a sensor for determining the position of the actuating element, wherein the sensor is connected to the control unit in terms of signal technology.

15. A method for installing an electromechanical wheel brake as claimed in claim 1, wherein, for installing the wheel brake, the transmission assembly is coupled to the clamping device along the clamping direction, and wherein the electromotive drive assembly is coupled to the transmission assembly perpendicular to the clamping direction.
